(19) United States
(12) Patent Application Publication
(10) Pub. No.: US 2019/0343085 A1
(43) Pub. Date: Nov. 14, 2019

(54) DOG LEASH SUPPORTING CLAMP SYSTEM

(71) Applicant: Vanessa Donado, Miami, FL (US)

(72) Inventor: Vanessa Donado, Miami, FL (US)

(21) Appl. No.: 16/409,762

(22) Filed: May 10, 2019

Related U.S. Application Data
(60) Provisional application No. 62/669,938, filed on May 10, 2018.

(51) Int. Cl. A01K 27/00

(52) U.S. Cl. CPC A01K 27/003; A01K 27/001; A01K 27/005

(57) ABSTRACT

A dog leash supporting clamp system including a clamping member having a threaded aperture for receiving a threaded screw and a 360-degree rotatable swivel clip. The clamping member includes an open-end for securing the clamp assembly to an edge of a flat surfaced item such as a table or chair. The threaded screw is able to be tightened within the threaded aperture via a handle, thereby closing a gap between a top-portion and a bottom-portion of the clamping member to clamp to the edge of the flat surfaced item. The clip is affixed to the threaded screw and may removably receive a pet leash and support the pet leash at an adjustable length.

### CROSS REFERENCE TO RELATED APPLICATION

The present application is related to and claims priority to U.S. Provisional Patent Application No. 62/669,938 filed May 10, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of pet accessories and more specifically relates to clamps and clips.

### 2. DESCRIPTION OF RELATED ART

When taking a dog to public places, the dog's leash may need to be tied to a post, chair leg, table, and the like to secure the dog in place. The owner may tie the leash to the object and then let the leash rest on the ground. The dog may try to move and/or run around, getting the leash tangled in chairs and tables. Pet owners will have to constantly stand up in order to untangle their dog. A suitable solution is desired.

U.S. Pub. No. 2017/0318787 to Sam Osta relates to a tangle-free pet collar. The described tangle-free pet collar includes a tangle-free pet collar apparatus to be worn around the neck of an animal. The collar apparatus includes an outer wheel and an inner wheel, that when the inner wheel is set within the outer wheel a bearing is formed. The inner wheel and said outer wheel are free to rotate about each other upon forming a bearing. The collar apparatus further includes an elongated length of material having a first end and a second end, at least one inner wheel connection mechanism for attaching a leash, and at least one outer wheel connection mechanism. The first and second end of the elongated length of material, when fastened to the outer wheel, forms a collar for wearing about an animal's neck. This collar apparatus keeps the leash from tangling or knotting in addition to solving additional unmet needs.

### BRIEF SUMMARY OF THE INVENTION

In view of the foregoing disadvantages inherent in the known pet accessories art, the present disclosure provides a novel dog leash supporting clamp system. The general purpose of the present disclosure, which will be described subsequently in greater detail, is to provide users with a C-clamp device capable of being attached on chairs, tables, and other flat surfaces, designed to secure a dog leash at a desired length.

A dog leash supporting clamp system is disclosed herein. The dog leash supporting clamp system includes a clamp assembly including a clamping member having a threaded screw and a swivel clip. The clamping member comprises a top-portion and a bottom-portion. The bottom-portion comprises a threaded aperture configured to support the threaded screw. The clamping member comprises an open-end for securing the clamp assembly to an edge of a flat surfaced item such as but not limited to a chair or a table. The threaded screw comprises a first-end, a second-end, and a length disposed therebetween. The first-end comprises a flat surface and the second-end comprises a handle. The threaded screw is able to be tightened within the threaded aperture via the handle, closing a gap between the top-portion and the bottom-portion to clamp the edge of the flat surfaced item. The clip is affixed to the threaded screw and configured to removably receive a pet leash and support the dog leash at an adjustable length in a tangle free manner.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dog leash supporting clamp system, constructed and operative according to the teachings of the present disclosure.

FIG. 1 is a front perspective view of the dog leash supporting clamp system during an ‘in-use’ condition, according to an embodiment of the disclosure.

FIG. 2 is a front perspective view of the dog leash supporting clamp system of FIG. 1, according to an embodiment of the present disclosure.

FIG. 3 is an exploded view of the dog leash supporting clamp system of FIG. 1, according to an embodiment of the present disclosure.

FIG. 4 is a side view of the dog leash supporting clamp system of FIG. 1, according to an embodiment of the present disclosure.

FIG. 5 is a side view of the dog leash supporting clamp system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pet accessory and more particularly to a dog leash supporting clamp system as used to improve the securement of pet leashes. The device features a swiveling latch which allows for easy insertion of the pet leash with full, three hundred sixty-degree motion.

The present invention effectively eliminates the need to try and tie a leash to a chair or table which can be ineffective and lead to a dog running away. Dog leash supporting clamp system is a modified clamp system designed to hold a dog leash at a desired length while the leash is attached to a table, chair, or other surface. The device is comprised of a C-clamp with a screw tightening mechanism. The screw keeps the clamp secured to the surface when applied to the clamp. The open end of the clamp may be secured to a chair, table, etc. and the screw can be tightened for securement. The clamp includes a swiveling latch which allows easy insertion of the pet leash with 360-degree motion. The clamp is intended to prevent leashes from becoming tangled if the pet runs around a table or chair. The leash length is intended to keep a pet comfortable and close by while the owner sits. Dog leash supporting clamp system can be constructed using aluminum, plastic, and other suitable materials. The clamp may be covered in rubber materials of varying colors to add a functional aesthetic design. The clamp may be available in various sizes in order to accommodate all user needs and preferences.

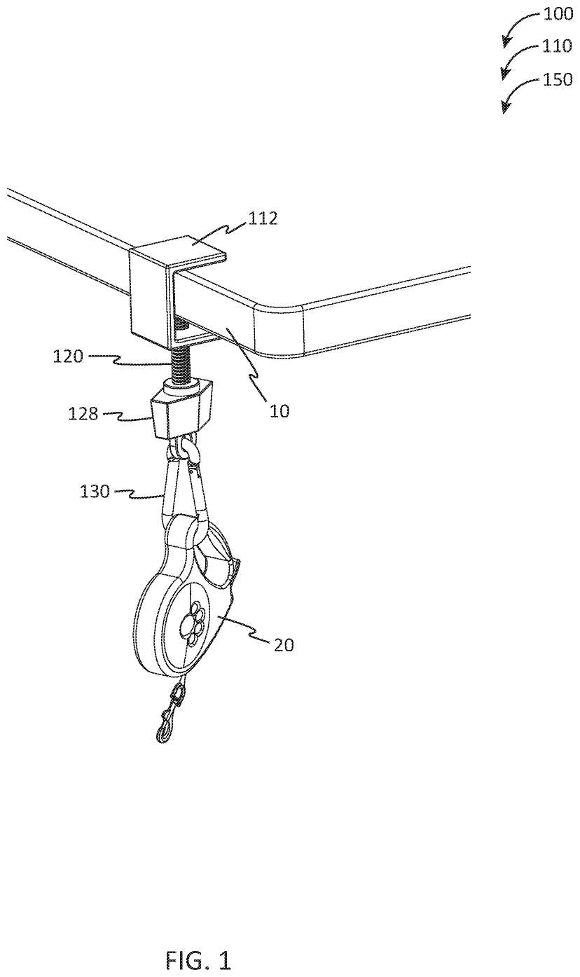

Referring now more specifically to the drawings by numerals of reference, there is shown in FIGS. 1-5, various views of a dog leash supporting clamp system 100. FIG. 1 shows a dog leash supporting clamp system 100 during an ‘in-use’ condition 150, according to an embodiment of the present disclosure. As illustrated, the dog leash supporting clamp system 100 may include a clamp assembly 110 comprising a clamping member 112 having a threaded screw 120 and a swivel clip 130 in functional combination. The clamping member 112 comprises a top-portion 114 and a bottom-portion 116. The bottom-portion 116 includes a threaded aperture 118 configured to support the threaded screw 120. The clamping member 112 comprises an open-end 140 for securing the clamp assembly 110 to an edge of a flat surfaced item 10. The threaded screw 120 comprises a first-end 122, a second-end 124, and a length 126 disposed therebetween. The first-end 122 comprises a flat surface and the second-end 124 comprises a handle 128. The threaded screw 120 is able to be tightened within the threaded aperture 118 via the handle 128, closing a gap between the top-portion 114 and the bottom-portion 116 to clamp the edge of the flat surfaced item 10. The swivel clip 130 is affixed to the threaded screw 120 and configured to removably receive a pet leash 20 and support the pet leash 20 at an adjustable length.

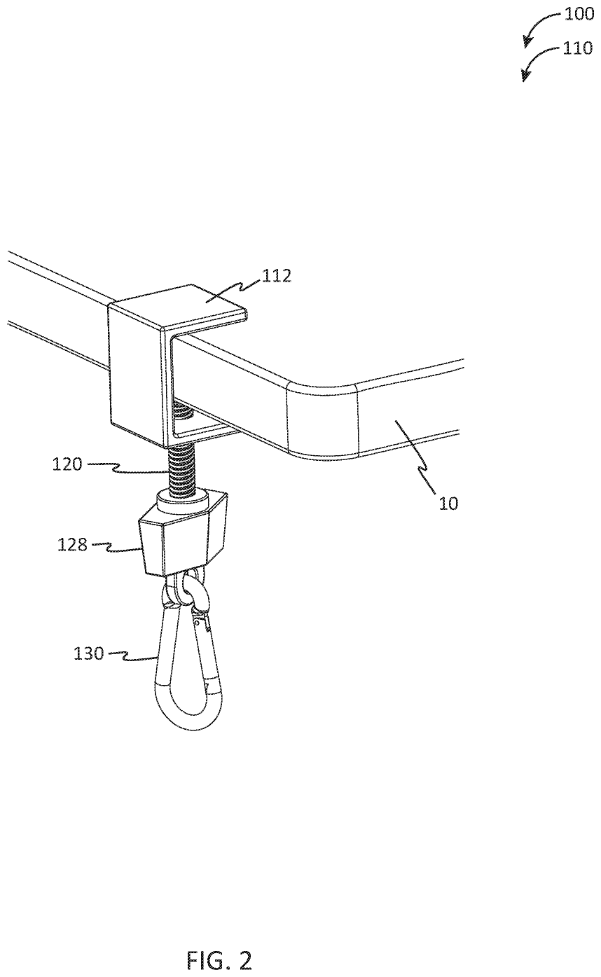

FIG. 2 shows a perspective view of the dog leash supporting clamp system 100 of FIG. 1, according to an embodiment of the present disclosure. As above, the dog leash supporting clamp system 100 may include the clamp assembly 110 comprising the clamping member 112 having the threaded screw 120 and the swivel clip 130 used for securing a pet leash 20 to a table, chair, desk, or the like. In a preferred embodiment, the clamping member 112 is a c-clamp having a substantially c-shaped profile. The top-portion 114 of the clamping member 112 comprises a planer inner surface and the bottom-portion 116 also has a planar inner surface. The top-portion 114 of the clamping member 112 and the bottom-portion 116 of the clamping member 112 comprise equal lengths. The top-portion 114 is in contact with a top surface of a chair, table, or other flat surfaced item 10 during an engaged, in-use condition.

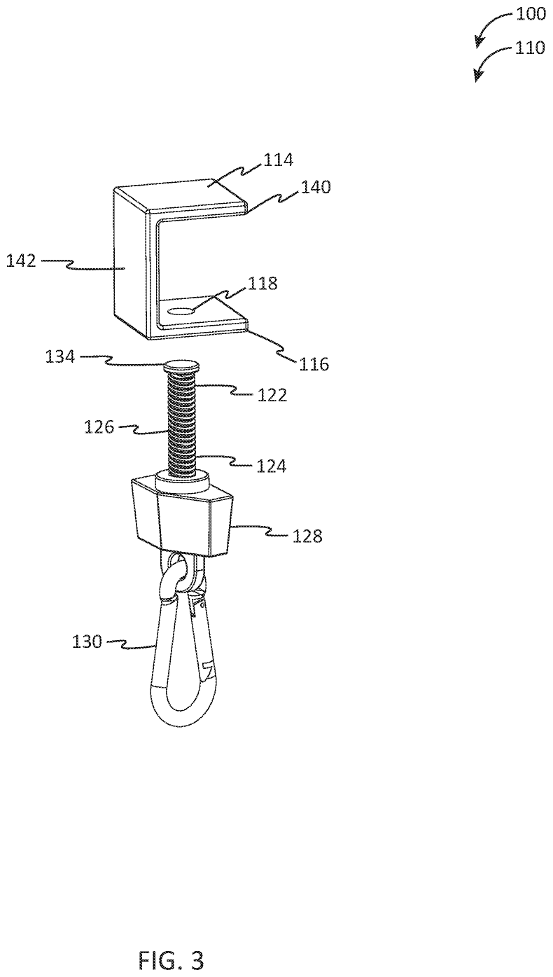

FIG. 3 shows an exploded view of the dog leash supporting clamp system 100 of FIG. 1, according to an embodiment of the present disclosure. As above, the dog leash supporting clamp system 100 may include the clamp assembly 110 comprising the swivel clip 130 which is configured to swivel 360 degrees in a preferred embodiment. The swivel clip 130 comprises a carabiner clip having a latch 132 configured to open to receive the pet leash 20 and alternatively close to retain the pet leash 20 within the swivel clip 130. The first-end 122 of the threaded screw 120 may include a foam-member 134, as shown in FIG. 3. The foam-member 134 is in contact with a bottom surface of the flat surfaced item 10 during an engaged, in-use condition. The threaded screw 120 and the swivel clip 130 may be detachable from the clamping member 112 or the threaded screw 120 may be secured within the threaded aperture 118 to prevent full removal of the threaded screw 120 from the clamping member 112.

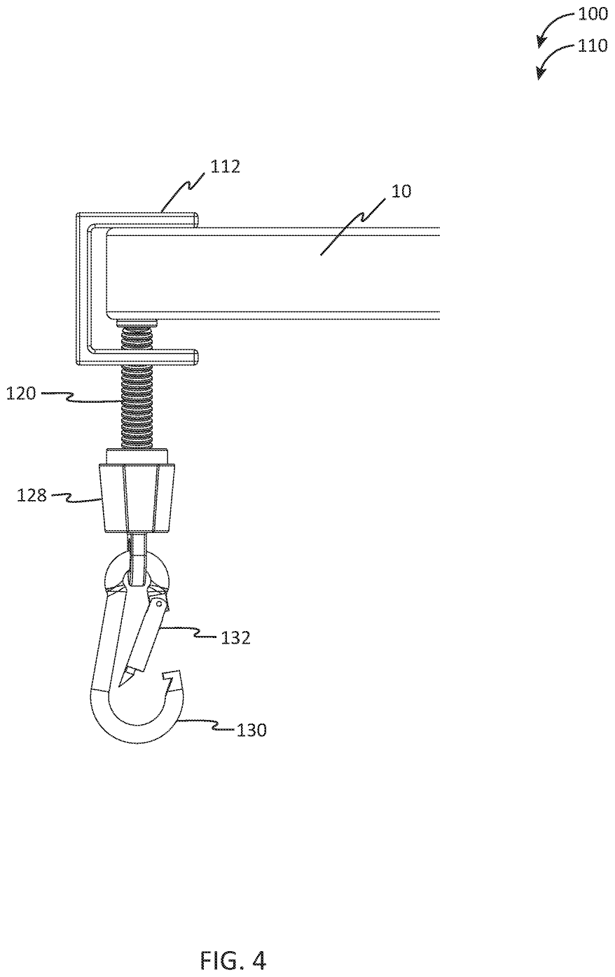

FIG. 4 shows a side view of the dog leash supporting clamp system 100 of FIG. 1, according to an embodiment of the present disclosure. As above, the dog leash supporting clamp system 100 may include the clamping member 112 configured to secure the device to a table, chair or other item. The clamping member 112 further comprises a closed-end 142 opposing the open-end 140. The closed-end 142 may have a curved or non-curved profile such that the clamping member 112 contours to the edge of a flat surfaced item 10. As previously mentioned, the clamping member 112 includes a handle 128, knob or other user control which allows a user to rotate the threaded screw 120. In one embodiment, the handle 128 is positioned perpendicular to the threaded screw 120 forming a T-shape. The handle 128 may include an elongated bar affixed to the second-end 124 of the threaded screw 120. The user may rotate the handle 128 to tighten and alternatively loosen biasing of the clamping member 112.

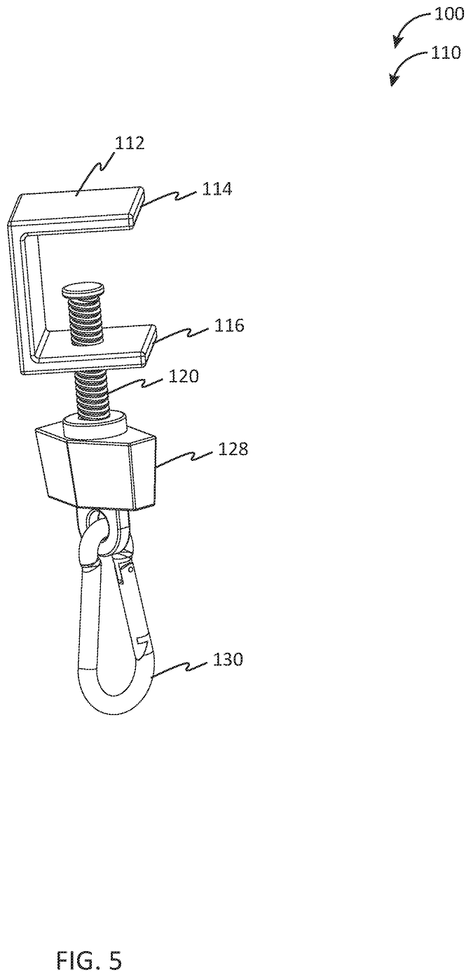

FIG. 5 shows a side view of the dog leash supporting clamp system 100 of FIG. 1, according to an embodiment of the present disclosure. As above, the dog leash supporting clamp system 100 may include the clamp assembly 110 comprising the clamping member 112 having the threaded screw 120 and the swivel clip 130 configured to support a pet leash 20 in a tangle-free manner. The swivel clip 130 is attached to the handle 128 of the threaded screw 120 or directly to the second-end 124 of the threaded screw 120 and provides 360 degree rotation. The clamping member 112 may comprise a rubber coating in certain embodiments.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dog leash supporting clamp system comprising:
a clamp assembly;
a clamping member having;
a threaded screw; and
a swivel clip:
wherein said clamping member comprises a top-portion and a bottom-portion, said bottom-portion comprises a threaded aperture configured to support said threaded screw;
wherein said clamping member comprises an open-end for securing said clamp assembly to an edge of a flat surfaced item;
wherein said threaded screw comprises a first-end, a second-end, and a length disposed therebetween, said first-end comprises a flat surface and said second-end comprises a handle;
wherein said threaded screw is able to be tightened within said threaded aperture via said handle, closing a gap between said top-portion and said bottom-portion to clamp said edge of said flat surfaced item; and
wherein said swivel clip is affixed to said threaded screw and configured to removably receive a pet leash and support said pet leash at an adjustable length.

2. The dog leash supporting clamp system of claim 1, wherein said flat surfaced item is selected from a group consisting of a table, desk, and a chair.

3. The dog leash supporting clamp system of claim 1, wherein said clamping member is a c-clamp having a substantially c-shaped profile.

4. The dog leash supporting clamp system of claim 3, wherein said top-portion of said clamping member comprises a planer inner surface and said bottom-portion having a planar inner surface.

5. The dog leash supporting clamp system of claim 1, wherein said top-portion of said clamping member and said bottom-portion of said clamping member comprise equal lengths, said top-portion being in contact with a top surface of said flat surfaced item during an engaged, in-use condition.

6. The dog leash supporting clamp system of claim 1, wherein said swivel clip is configured to swivel.

7. The dog leash supporting clamp system of claim 6, wherein said swivel clip is configured to swivel 360 degrees.

8. The dog leash supporting clamp system of claim 7, wherein said swivel clip comprises a latch configured to open to receive said pet leash and alternatively close to retain said pet leash within said swivel clip.

9. The dog leash supporting clamp system of claim 8, wherein said swivel clip comprises a carabiner clip.

10. The dog leash supporting clamp system of claim 1, wherein said clamping member further comprises a closed-end.

11. The dog leash supporting clamp system of claim 10, wherein said closed-end comprises a curved profile.

12. The dog leash supporting clamp system of claim 10, wherein said closed-end comprises a non-curved profile

13. The dog leash supporting clamp system of claim 1, wherein said handle is positioned perpendicular to said threaded screw.

14. The dog leash supporting clamp system of claim 13, wherein said handle comprises an elongated bar affixed to said second-end of said threaded screw.

15. The dog leash supporting clamp system of claim 1, wherein said swivel clip is attached to said handle of said threaded screw.

16. The dog leash supporting clamp system of claim 1, wherein said swivel clip is attached to said second-end of said threaded screw.

17. The dog leash supporting clamp system of claim 1, wherein said first-end of said threaded screw comprises a foam-member, said foam-member being in contact with a bottom surface of said flat surfaced item during an engaged, in-use condition.

18. The dog leash supporting clamp system of claim 1, wherein said clamping member further comprises a rubber coating.

19. The dog leash supporting clamp system of claim 1, wherein said threaded screw and said swivel clip are detachable from said clamping member.

20. A dog leash supporting clamp system, the dog leash supporting clamp system comprising:
a clamp assembly;
a clamping member having;
a threaded screw; and
a swivel clip:
wherein said clamping member is a c-clamp having a substantially c-shaped profile;
wherein said clamping member comprises a top-portion and a bottom-portion, said bottom-portion comprises a threaded aperture configured to support said threaded screw;
wherein said clamping member comprises an open-end for securing said clamp assembly to an edge of a flat surfaced item;
wherein said flat surfaced item is selected from a group consisting of a table, desk, and a chair,
wherein said top-portion of said clamping member comprises a planer inner surface and said bottom-portion having a planar inner surface;
wherein said top-portion of said clamping member and said bottom-portion of said clamping member comprise equal lengths, said top-portion being in contact with a top surface of said flat surfaced item during an engaged, in-use condition;
wherein said threaded screw comprises a first-end, a second-end, and a length disposed therebetween, said first-end comprises a flat surface and said second-end comprises a handle;
wherein said threaded screw is able to be tightened within said threaded aperture via said handle, closing a gap between said top-portion and said bottom-portion to clamp said edge of said flat surfaced item;
wherein said swivel clip is affixed to said threaded screw and configured to removably receive a pet leash and support said pet leash at an adjustable length;
wherein said swivel clip is configured to swivel 360 degrees:
wherein said swivel clip comprises a latch configured to open to receive said pet leash and alternatively close to retain said pet leash within said swivel clip;
wherein said swivel clip comprises a carabiner clip;
wherein said clamping member further comprises a closed-end configured to contour to said edge of said flat surfaced item during an engaged, in-use condition;
wherein said handle is positioned perpendicular to said threaded screw;
wherein said handle comprises an elongated bar affixed to said second-end of said threaded screw;
wherein said first-end of said threaded screw comprises a foam-member, said foam-member being in contact with a bottom surface of said flat surfaced item during said engaged, in-use condition; and
wherein said clamping member further comprises a rubber coating.
